(19) United States
(12) Patent Application Publication
(10) Pub. No.: US 2013/0003715 A1
(43) Pub. Date: Jan. 3, 2013

(54) CONNECTION SETUP FOR LOW ENERGY WIRELESS NETWORKS BASED ON MASTER DEVICE PACKET THAT INCLUDES TIMING INFORMATION

(75) Inventors: Ariton E. Xhafa, Plano, TX (US); Jin-Meng Ho, Plano, TX (US)

(73) Assignee: Texas Instruments Incorporated, Dallas, TX (US)

(21) Appl. No.: 13/526,658

(22) Filed: Jun. 19, 2012

Related U.S. Application Data
(60) Provisional application No. 61/502,665, filed on Jun. 29, 2011.

(51) Int. Cl. H04L 12/56; H04W 88/02

(52) U.S. Cl. 370/349

(57) ABSTRACT

An apparatus includes a controller configured to cause a wireless transceiver to send and receive wireless packets. The controller is configured to receive a packet from another wireless device. The packet specifies a scan window length, a scan interval, and a start time. Based on the start time, scan interval, and a current time, the controller is configured to compute when a subsequent scan window will begin and the wireless transceiver does not transmit advertising packets until the subsequent scan window begins.

### CROSS-REFERENCE TO RELATED APPLICATION

The present application claims priority to U.S. Provisional Patent Application No. 61/502,665 filed on Jun. 29, 2011 (Attorney Docket No. TI-71080 PS) titled “Connection Setup for Low Energy Wireless Networks;” which is hereby incorporated herein by reference.

### BACKGROUND

Bluetooth Low Energy (BLE) is a wireless radio technology, aimed at new, principally low-power and low-latency applications for wireless devices within a short range (up to about 160 feet). BLE networks are particularly well-suited for a wide range of applications and smaller form factor devices in the healthcare, fitness, security and home entertainment industries. As its name implies, BLE is intended for such energy-constrained applications as a sensor or a disposable device, particularly those that transmit relatively little data and do so infrequently. BLE was designed to enable wireless connectivity with small devices running for extended periods of time on, for example, a coin cell battery. While an objective of networks that utilize BLE technologies is robust and secure delivery of information, saving battery power is also a concern.

### SUMMARY

Various techniques for connection setup for Bluetooth Low Energy (BLE) devices are disclosed. The various embodiments save power. In one example, a BLE master generates and transmits a packet that includes timing information about its scan interval and scan window. For example, an apparatus may include a controller configured to cause a wireless transceiver to send and receive wireless packets. The controller is configured to receive a packet from another wireless device. The packet specifies a scan window length, a scan interval, and a start time. Based on the start time, scan interval, and a current time, the controller is configured to compute when a subsequent scan window will begin and the wireless transceiver does not transmit advertising packets until the subsequent scan window begins.

Another embodiment is directed to a method that includes receiving a wireless packet that specifies a scan window length, a scan interval, and a start time. Further, based on the start time, scan interval, and a current time, the method includes computing when a subsequent scan window will begin.

An apparatus preferably includes a controller configured to cause a wireless transceiver to send and receive packets. The controller is configured to generate a scan update packet that specifies a scan window length, a scan interval, a start time and an end time. The scan window length and scan interval are valid between the start time and the end time.

### BRIEF DESCRIPTION OF THE DRAWINGS

Having thus described the invention in general terms, reference will now be made to the accompanying drawings, which are not necessarily drawn to scale, and wherein:

FIG. 1 shows a master device in wireless communication with a slave in accordance with various embodiments;

FIG. 2 shows an illustrative implementation of a slave or master device in accordance with various embodiments;

FIG. 3 illustrates advertising ADV_IND packets and responses in accordance with various embodiments;

FIG. 4 illustrates advertising ADV_DIR_IND packets and responses in accordance with various embodiments;

FIG. 5 shows a method in accordance with various embodiments in which a scan window and scan interval are estimated in a calibration process implemented on a slave device in accordance with various embodiments;

FIG. 6 illustrates a time line depicting the calibration process in accordance with various embodiments;

FIG. 7 shows a method in which a slave device uses the estimates from the method of FIG. 5 in accordance with various embodiments;

FIG. 8 illustrates a packet usable by a master device to specify to slave devices the scan window and scan interval in accordance with various embodiments;

FIG. 9 depicts a timeline example in which the current time is in the dead time between scan windows in accordance with various embodiments;

FIG. 10 depicts a timeline example in which the current time is within a scan window in accordance with various embodiments; and

FIG. 11 shows a method in which a slave device estimate uses scan update information provided by a master device in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct connection, or through an indirect connection via other devices and connections. The terms “packet” and “frame” are used interchangeably in this disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In some wireless networks, wireless devices set up connections with each other to facilitate data transfer. This disclosure focuses on BLE networks, but the scope of the disclosure and the claims applies to other network types as well. The problem with the connection setup process is that a BLE slave device spends a great deal of time in the connection setup phase. In general, a BLE device may operate in different modes depending on required functionality. The main modes of operation include the advertising mode, the scanning mode, master device mode, and slave device mode. In advertising mode, the BLE device periodically transmits advertising packets and may respond with more information upon request from other devices. In the scanning mode, a BLE device listens for and receives advertising packets transmitted by other devices and may request additional information from the originator of an advertising packet. A slave device connects to a single master, but a master may connect to multiple slave devices simultaneously.

To establish a connection, a first BLE device transmits an advertising frame. A second BLE device responds to the advertising frame and may request additional information. If additional information is requested, the first device transmits the requested information. The connection can then be established with the first device being the slave device and the second device being the master device. In this disclosure, references to “slave device” refer to the BLE device that sends out the advertising packets, and the “master device” is the BLE device that receives and responds to the advertising packets.

A slave device transmits advertising packets such as advertising indicator (ADV_IND) and advertising directed (ADV_DIRECTED_IND which is the same as ADV_DIR_IND in FIG. 4) packets. And ADV_DIRECT_IND packet is directed to a specific master device and contains the medium access control (MAC) address of the target master device. The ADV_DIRECT_IND packet indicates that the slave device wants to connect to that specific master device to establish a connection. The ADV_IND packet is not specific to any particular master device and indicates the presence of the slave device.

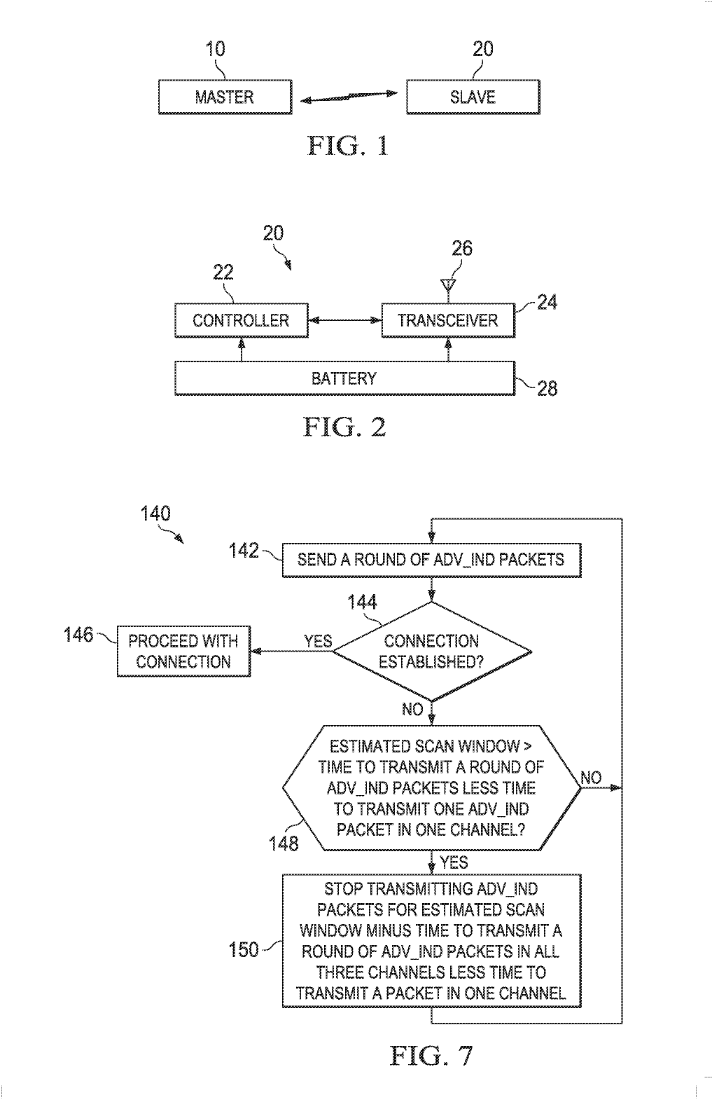

FIG. 1 shows two wireless devices 10 and 20. Wireless device 10 is a master device and wireless device 20 is a slave device. As noted above, to establish a connection between the master and slave devices 10, 20, the slave device 20 transmits an advertising packet which, if received by the master 10, indicates the presence of the slave device 20 to the master device. The master device 10 may respond with a scan request (SCAN_REQ) packet. The slave device 20 responds to the SCAN_REQ with a scan response (SCAN_RSP) packet to provide additional data if necessary before establishing the connection. The master and slave devices 10, 20 thus engage in information exchange before establishing a connection.

FIG. 2 illustrates a block diagram of a slave device 20. As shown, the slave device 20 includes a controller 22, a transceiver 24, an antenna 26, and a battery 28. The battery 28 provides electrical power to the controller 22 and transceiver 24. The transceiver 24 accepts signals from the controller 22 to transmit wirelessly via antenna 26. Similarly, wireless signals received by the antenna 26 are provided by the transceiver 24 to the controller 22 for processing. The transceiver 24 thus is capable of bi-directional data communications with another wireless device such as a master device 10. The controller 22 may comprise a processor executing software. The controller 22 preferably performs some or all of the functionality described herein as attributed to the slave device 20. The architecture depicted in FIG. 2 may be used as well to implement the master device 10.

In the BLE protocol, channels 37, 38, and 39 (also referred to as a “channel index”) are dedicated for use in transmitting advertising packets and the associated responses. The master device 10 listens on each advertising channel for a scan window interval of time (“scanWindow”). The scan interval (“scan Interval”) is defined as the time between two consecutive scan windows. During each scanInterval, the master device 10 listens for the scanWindow interval unless there is a scheduling conflict. The master device replies to ADV_IND or ADV_DIRECT_IND packets that it receives during the scanWindow interval.

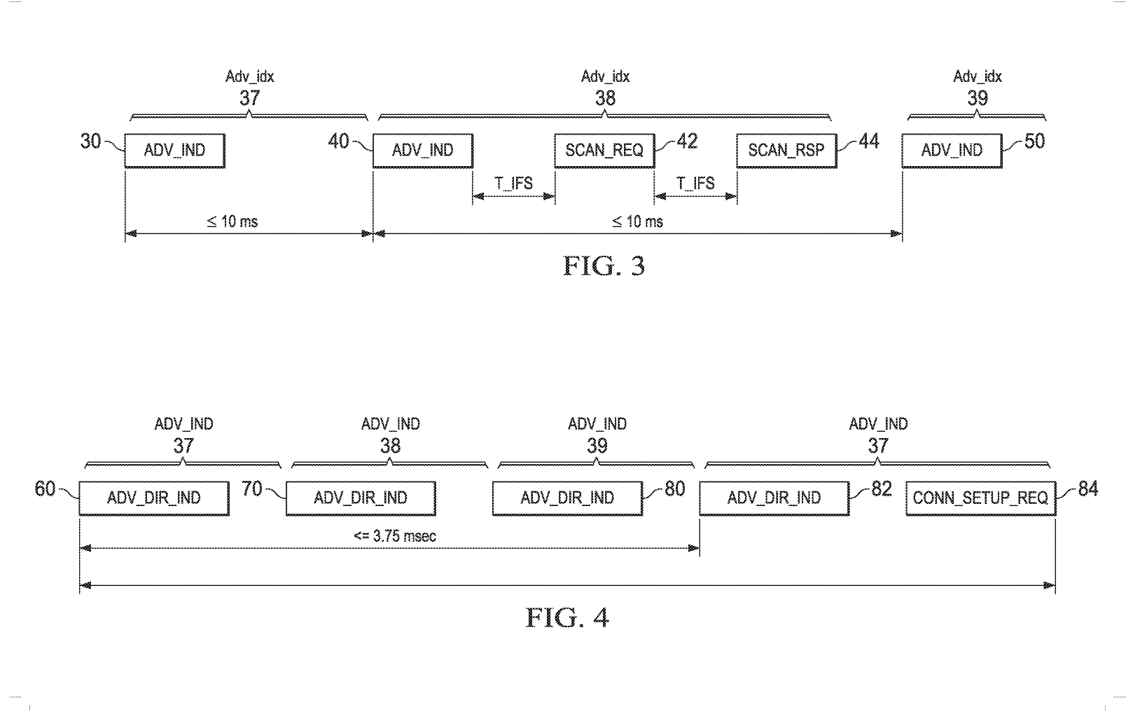

FIGS. 3 and 4 illustrate examples of a BLE master response to advertising packets from a BLE slave. FIG. 3 illustrates the slave device 20 transmitting an ADV_IND packet in each of the three advertising channel indexes 37-39 dedicated for such purpose as noted above. Transmitting an advertising packet in each of the three dedicated advertising channel indexes is referred to herein as a “round” of advertising packets. In FIG. 3, the master device 10 does not respond to the advertising packets 30 and 50 in channel indexes 37 and 39, but does reply to the advertising packet 40 in channel index 38 with a scan request (SCAN_REQ) frame 42 requesting additional information from the slave device 20 in order to establish a connection. The slave device responds with a scan response (SCAN_RSP) frame 44 to provide all such requested information.

As shown in the example of FIG. 3, the ADV_IND advertising packets 30, 40, and 50 are transmitted, one after the other but at an interval of at most 10 msec. Thus, a round of advertising packets takes at most 30 msec.

The scan window in which the master device 10 listens for advertising packets is a portion of the scan interval. During the remaining portion of the scan interval, the master device 10 does not respond to advertising packets from slave devices and thus that portion of the scan interval is referred to herein as “dead” time. If the slave device starts sending advertising packets after the scanWindow interval has ended (i.e., during the dead time), then, during the portion of the scan interval that is outside the scanWindow the slave device may transmit as many as 3(scanInterval−scanWindow)/30 msec advertising packets that will go unanswered by a master device. These advertising packets thus waste energy by the slave device.

In FIG. 4, the slave device sends directed advertising frames (ADV_DIR_IND) to a specific master device. A pair of master and slave devices may have already connected at some prior time; however, the connection may have been lost or ended for whatever reason. At any rate, the slave device wants to reestablish the connection to the same master device. In the example of FIG. 4, the master device does not reply to the first two ADV_DIR_{—} IND frames 60 and 70 but does reply to the third ADV_DIR_IND frame 80 with a connection setup request frame (CONN_SETUP_REQ) 84 conveying connection specific information to slave.

As shown in the example of FIG. 4, the ADV_DIR_IND advertising packets 60-80 are transmitted with all three packets transmitted in a time period of 3.75 msec. Thus, a round of master-specific advertising packets takes 3.75 msec. If the slave device starts sending advertising packets after scanWindow interval has ended, then the slave device may transmit as many as 3*(scanInterval−scanWindow)/3.75 msec ADV_DIR_IND frames that will go unanswered by a master device thus wasting energy.

The examples above illustrate that there is a portion of each window interval (the “dead” time) in which a slave will expend energy to transmit advertising frames that go unanswered. In accordance with the preferred embodiments of the invention, the slave device does not transmit as many advertising frames during the period of time that the master device is not likely to respond to the slave device's advertising frames. Various embodiments of the invention will now be described to improve the connection setup for slave devices. Such embodiments result in a power savings.

### Scan Interval Estimation by Slave Device

In one embodiment, the slave device 20 estimates the scan window and scan interval time periods based on responses, or lack thereof, from a master device to advertising packets. The slave device then uses the estimated scan window and scan interval values to establish future connections with the master device 10.

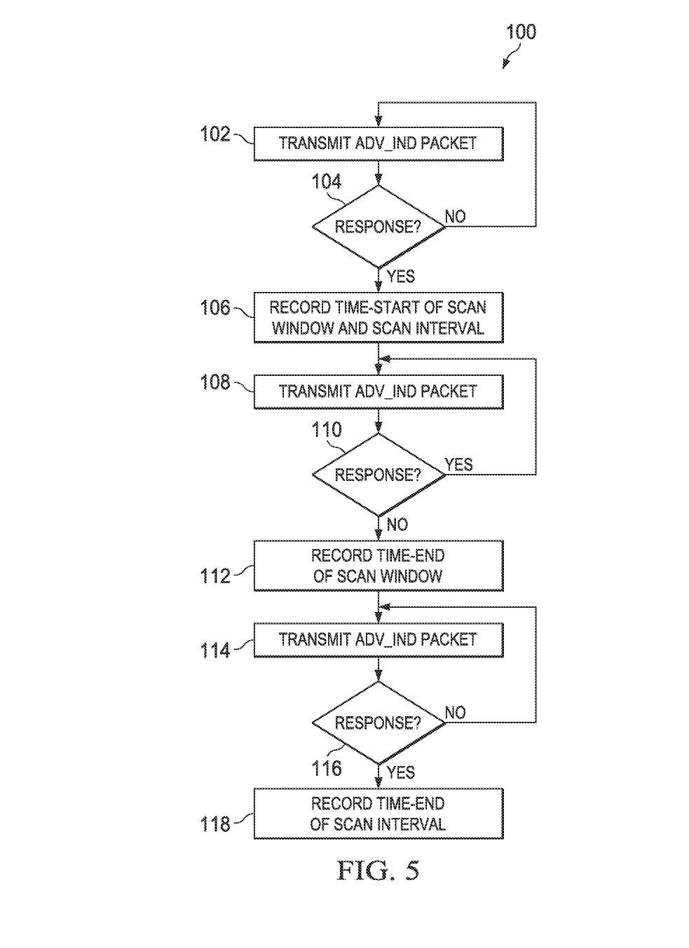

FIG. 5 illustrates a method 100 for estimating the size of the scan window and scan interval for a given master. The actions depicted in FIG. 5 may be performed in the order shown, or in a different order. Further, two or more of the actions may be performed in parallel rather than serially. The method depicted in FIG. 5 is a calibration routine performed by the slave device 20 one time, although the slave device can perform the calibration routine more than once as desired. At the end of the calibration routine depicted in FIG. 5, the slave device will have computed an estimate of the master's scan window and scan interval.

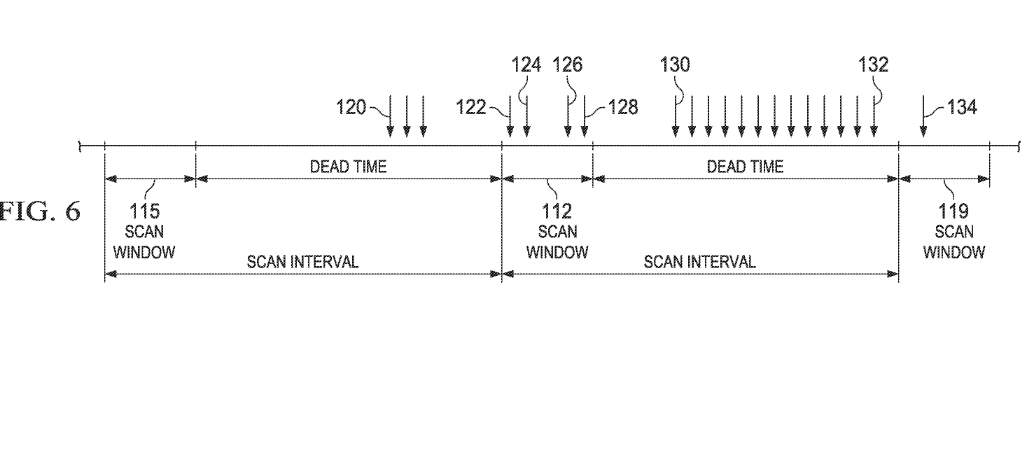

Referring briefly to FIG. 6, three scan windows 115, 117, and 119 are depicted. The scan interval also is shown. Reference will be made to FIG. 6 as the method 100 of FIG. 5 is explained. At 102, the slave device 20 begins transmitting ADV_IND packets. In FIG. 5, references to transmitting an advertising packet preferably means transmitting a round of advertising packets in the various advertising channels. The first such packet is shown in the example of FIG. 6 at 120. The slave device 20 will receive a response (e.g., SCAN_REQ) from a master device 10 if the ADV_IND packet happens to have been transmitted while the master device is in its scanning mode defined by its scan window. However, the slave device 20 still will not know in which portion of the scan window the ADV_IND packet was sent. On the other hand, the slave device 20 may have sent the ADV_IND packet during the “dead” time between scan windows in which the master device will not respond to ADV_IND packets. And in that situation, the slave device will not know in which portion of the dead time it sent the ADV_IND packet. All that the slave device 20 can determine is whether the ADV_IND packet was sent during the dead time or during a scan window.

If a response to the ADV_IND packet is not received (104), which will be the case for the ADV_IND packet 120 in FIG. 6, then the slave device 20 determines that the advertising packet was sent during the dead time. The slave device 20 is attempting to find the beginning of the next scan window and thus the slave device repeatedly sends additional advertising packets until a response is received from a master device, which will occur as a result of the slave device transmitting advertising packet 122 at the beginning of scan window 117.

When the slave device 20 finally does receive a response (e.g., SCAN REQ) from a master, the slave device determines that it is now in a scan window. As such, the slave device at 106 records the time that the response was received or that the advertising packet 122 was transmitted. The recorded time is an estimate of the beginning of the scan window 118 as well as the beginning of the scan interval. In an alternative embodiment, the slave device may start a timer to measure the length of the scan window and a separate timer to measure the length of the scan interval.

Now that the slave device 20 has found the beginning of the scan window and scan interval, the slave device continues transmitting advertising packets at 108 in an attempt to find the end of the scan window (specifically the end of scan window 117 in FIG. 6). As long as responses to advertising packets are received (110), the slave device determines that the master is still in the scanning mode (i.e., still in the scan window). In the example of FIG. 6, master responses are received for advertising packets 124, 126, and 128.

As soon as the slave device fails to receive a response for an advertising packet, then the slave device determines that it has left the scan window and has found the beginning of the dead time. In FIG. 6, the slave device will not receive a response for advertising packet 130. Once that determination is made, the slave device 20 again records the time (112) which will indicate the end of the scan window, or stop the scan window timer if a timer is used. The slave device 20 can now estimate the length of the scan window by subtracting the starting time from the ending time, or noting the time value on the timer.

The slave device 20 continues transmitting advertising packets at 114 in an attempt to find the end of the dead time which is also the beginning of the next scan window 119. As long as no responses are received, (116) the slave device determines that it is still in the dead time, and continues sending advertising packets. The last advertising packet the slave device will transmit in the dead time and thus without a response is packet 132. The next packet 134 is transmitted in the next scan window 119 and thus a response will be generated by the master device and received by the slave device. At that point, the slave device 118 again records the time which indicates the end of the scan interval, or stops the scan interval timer. The length of the scan interval can be estimated by subtracting the starting time as recorded at 106 (for packet 122) from the ending time recorded at 118. Alternatively, the scan interval may be the time value in the scan interval timer if such a timer is used.

The estimation process described above is respect to a particular master device. If there is more than one master device in wireless vicinity of the slave device, then the slave device can distinguish such master devices based on the responder address (either on the scan request or another frame). The slave device may maintain different tags for each master device for this purpose.

The scan window and interval can be estimated as the maximum of the measured time values over all of the advertising channels. Separate statistics for each channel can also be used if desired. Further, the estimates of the scan window and scan interval can be increased to improve accuracy. For example, for a scanWindow value of 100 msec and interval between ADV_IND packets within a round of packets in the various advertising channels, the maximum error that can be made is 30 msec. However, if the interval between ADV_IND packets is reduced to 5 msec then the maximum error is about 15 msec. This implies that the accuracy can be increased from 70% to 85%. The estimate for the scan window may be increased from that determined in the process of FIG. 5 by the amount of the maximum error.

FIG. 7 illustrates a method 140 for how the slave device 20 uses the estimated scan window and scan interval to determine when to cease transmitting ADV_IND packets. The actions depicted in FIG. 5 may be performed in the order shown, or in a different order. Further, two or more of the actions may be performed in parallel rather than serially.

At 142, the slave device 20 sends a round of advertising packets. In the case of BLE, this means the slave device sending a single ADV_IND packet in each of the three advertising channels 37-39. If, as determined at 144, the slave device receives a scan request response (SCAN_REQ) for any of the ADV_IND packets, then a connection subsequently is established at 146. However, if the slave device does not receive a scan request response for any of the ADV_IND packets, then at 148, the slave device determines whether the estimated scan window is greater than the time required to transmit a round of ADV_IND packets less the time required to transmit a single ADV IND packet in a single advertising channel. If the determination is “no” at 148, then control loops back to 142 and the slave device sends another round of advertising packets.

If, however, the estimated scan window is indeed greater than the time required to transmit a round of ADV_IND packets less the time required to transmit a single ADV_IND packet in a single advertising channel, then at 150 the slave device temporarily ceases transmitting ADV_IND packets. Specifically, the slave device may stop transmitting advertising packets for a period of time equal to the estimated scan window minus the time required to transmit a round of ADV_IND packets less the time required to transmit a single ADV_IND packet in a single advertising channel. After the expiration of the time period in which the slave device ceases transmitting advertising packets, the slave device continues transmitting advertising packets in case the master device is now in the scan window and ready to receive advertising packets.

### Master-Initiated Update of Scan Interval Information

Another embodiment for reducing the number of advertising packets the slave device transmits is for the master device to advertise its scanning intervals at the time of connection setup or during a connection event via scan update procedures.

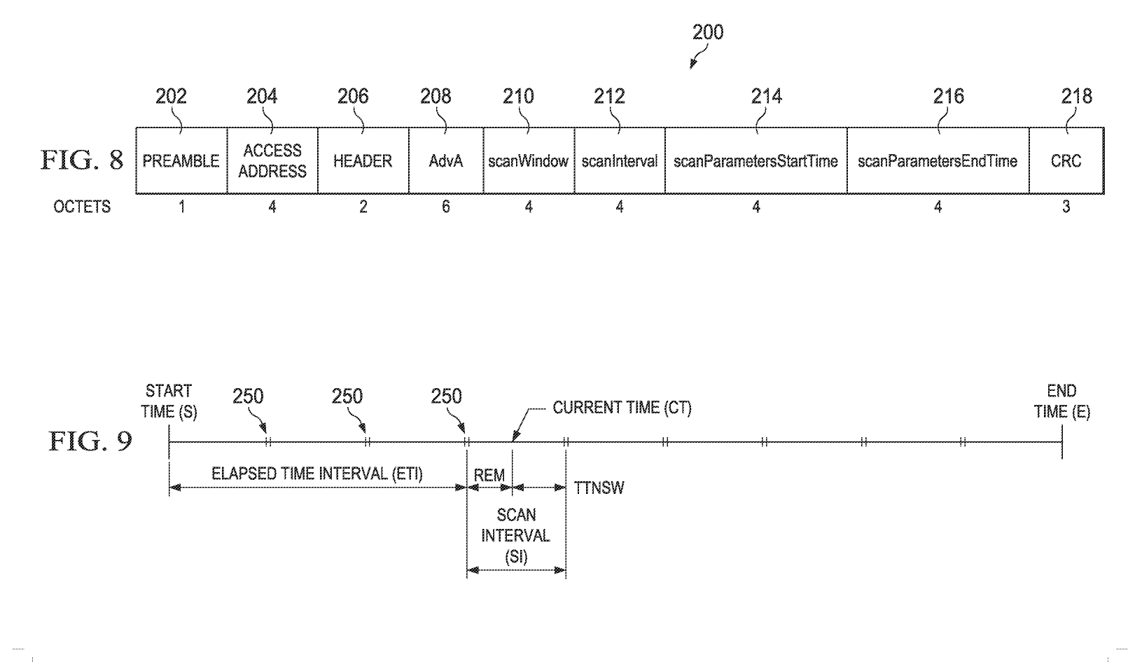

For example, the master device may send scan update frames at different channel advertising indexes during its scanWindow intervals before a connection to a slave is established. FIG. 8 illustrates a frame 200 format that can be used in this regard. The frame may be an ADV_SCAN_IND frame transmitted by the master device during its scan windows. Alternatively, a previously reserved frame type could be used such as frame types 0111 or 1111.

The frame illustrated in FIG. 6 is a scan update frame that is generated by the master device 10 and transmitted to the slave device 20. The illustrative frame 200 shown in FIG. 8 includes various fields including a preamble field 202, an access address field 204, a header field 206, an advertising address (AdvA) field 208, scanWindow field 210, a scanInterval field 212, a scanParametersStartTime field 214, a scanParametersEndTime field 216, and a cyclic redundancy code (CRC) field 208.

The preamble field 202 includes information used for radio synchronization. The access address field 204 is used for physical link identification. The header field 206 includes the type of Protocol Data Unit (PDU). For example, the PDU type may be set to 0110 to indicate the ADV_SCAN_IND packet type. The AdvA field 208 is used for the master address. The CRC field ensures correctness of the data in PDU.

The scanWindow field 210 and scanInterval 212 include values of the lengths of the scanWindow and scanInterval, respectively, for the master. The scanParameterStartTime field 214 and scanParametersEndTime field 216 include the starting and ending time for which the corresponding scanWindow and scanInterval values are valid.

The master device 10 may transmit scan update frames to slave devices 20 that are currently connected to the master device. The master device 10 may send such update frames because, for example, new slaves may have joined the network and the master device needs to update the scan intervals. This will take precedence over the previously setup scan intervals. Such update frames be transmitted during data channels (not advertising channels) and, as such may be a new frame type previously designated as a reserved frame type (e.g., 00b). Alternatively, an existing frame type could be used (e.g., LL control PDU) in which the sub-type is scan_update information. In one example, the opcode field in the header of the LL control PDU may define a new subtype (e.g., 0x0E) which is designated as LL_SCAN_UPDATE. In any case, the payload of the scan interval update frames includes scanWindow, scan Interval, scan ParameterStartTime, and scan ParametersEndTime.

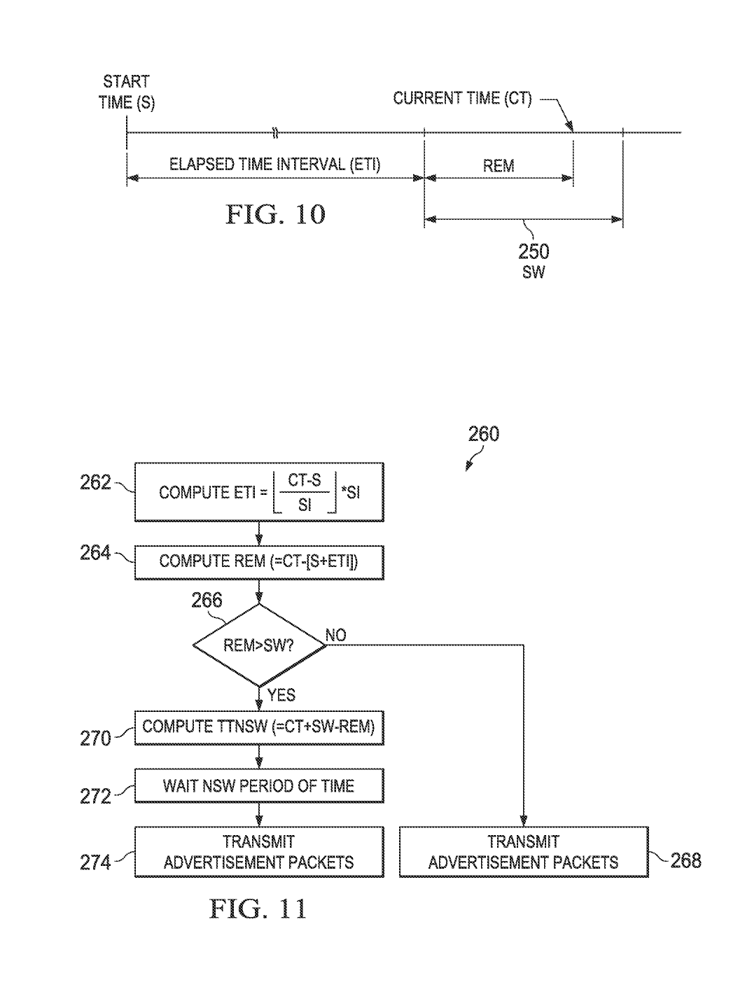

Any future connection setup between the master device and a slave device will be based on the information previously provided to such slaves in any of the aforementioned update frames (e.g., frame 200). FIG. 9 illustrates a time line having a start time (designated as “S” in FIG. 9) specified by the scanParameterStartTime field in packet 200, an end time (“E”) specified by the scanParametersEndTime field in packet 200, and a current time (“CT”). The values of S and E are provided in update frame (e.g., frame 200). The time line illustrates scan windows 250 and the scan interval (designated as “SI”). The current time (CT) is shown in the example of FIG. 9 in between two scan windows and thus in the dead time in which the master device is not listening for slave device advertising packets. FIG. 10 provides a time line example in which the current time (CT) is located within a scan window 250.

A slave device can estimate the start of the master device's scanWindow 250 in the case of the current time being in the dead time between scan windows. The current time and the scanParametersStartTime (S) can be used to calculate the number of scanIntervals (SIs) that have elapsed since the start time up to the current time. FIGS. 9 and 10 show an elapsed time interval (ETI) which is computed as:

ETI=└(CT−S)/SI┘*SI

The time remaining from the immediately preceding scan window 250 until the current time is shown in FIGS. 9 and 10 as REM and is computed as:

REM=CT−[S+ETI]

The remaining time (REM) is then compared to length of the scan window (SW) provided in the update frame. If REM is greater than scanWindow (which is the case in FIG. 9), then the slave device preferably waits until the start of the next scan window, which will occur at (CT+SW−REM) and is shown in FIG. 9 as TTNSW (time to next scan window). In the case of FIG. 10, REM is less than scanWindow which indicates that the current time is in the middle of a scan window. In this case, the slave device sends ADV_DIRECT_IND (or ADV_IND) frames to the master device to which it was previously connected.

FIG. 11 illustrates a corresponding method 260. The actions depicted in FIG. 11 can be performed in the order shown or in a different order and can be performed serially or in parallel.

At 262, the slave device 20 computes ETI as floor((CT−S)/SI)*SI. At 264, the slave device computes REM as CT−[S+ETI]. At 266, the slave device 20 determines whether REM is greater than SW (scan window length). If REM is less than SW, then at 268 the slave device transmits advertising packets.

If, however, REM is greater than SW, then at 270 the slave device computes NSW as C+SI−REM and then waits at 272 for the NSW period of time to ensure that the slave device is then in the master's scan window. At 274, after waiting NSW time, the slave device transmits advertising packets.

The maximum latency for connection setup is (SI−SW). During this interval though, the slave device 20 preferably does not need to send ADV_IND or ADV_DIRECT_IND frames to setup a connection. The slave device may need three frames to establish a connection with the master device if REM<SW, assuming that there are no collisions for the sent frames.

Furthermore, it is possible that, due to a scheduling conflict the master device 10 may not be able to perform scanning during some scan windows. The master device can convey this information in the connection setup phase or during connection events via additional fields that can be added to packet 200. In this scenario, the master can introduce a time offset and time off duration. The time offset indicates the start time within scanWindow interval that the time off duration starts. During the time off duration, the master may be serving other slave devices in the network (e.g., sending/receiving packets during already established connection events).

If the packet is conveyed during a connection setup phase, the time offset and time off are presumably for other slave devices in the network that does not include the current slave since connection has not yet been established. If the packet is conveyed during connection events, then the packet conveys the time offset and time off for other slave devices in the network that may include the current slave device. Inclusion of the current slave device would be to simplify the procedure at the master device and not send different packet payloads to different BLE slaves to convey scan updated parameters.

Note that additional fields may be added that can help/convey with finer granularity of scan intervals. The duration of the fields can change to accommodate the new fields added. For example, additional fields may specify that the scan interval comprises multiple scan windows of different durations and the duration of each such scan window. By way of an additional example, additional fields may specify that multiple alternating scan Intervals are implemented with their own start and end times.

In some embodiments, multiple packets can be sent to convey scan update information. This information can include additional time offset and time off field per slave device in the network or any other information that can help slave devices to know scan intervals. Under these scenarios, more data bits and/or additional packets that require scan update information could be included immediately following the packet type. This may accommodate scenarios where different slave devices have different connection intervals that simply “punch holes” in scanWindow interval.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An apparatus, comprising:
a controller configured to cause a wireless transceiver to send and receive wireless packets;
wherein the controller is configured to receive a packet from another wireless device, the packet specifying a scan window length, a scan interval, and a start time; and
wherein, based on the start time, scan interval, and a current time, the controller is configured to compute when a subsequent scan window will begin and the wireless transceiver does not transmit advertising packets until the subsequent scan window begins.

2. The apparatus of claim 1 wherein the received packet also includes an end time, and the start time and end time define when the scan window length and the scan interval are valid.

3. The apparatus of claim 1 wherein the controller computes when the subsequent scan window will begin by dividing a result of the current time minus the start time by the scan interval to compute an elapsed time interval.

4. The apparatus of claim 3 wherein the controller further computes when the subsequent scan window will begin by computing:
REM=current time−(start time+elapsed time interval)

5. The apparatus of claim 4 wherein the controller determines whether REM is greater than the scan window.

6. The apparatus of claim 5 wherein, based on REM being greater than the scan window, the controller waits a period of time equal to the current time plus the scan interval less REM before causing the wireless transceiver to transmit advertising packets.

7. The apparatus of claim 5 wherein, based on REM being less than the scan window, the controller causes the wireless transceiver to transmit advertising packets.

8. A method, comprising:
receiving a wireless packet that specifies a scan window length, a scan interval, and a start time; and
based on the start time, scan interval, and a current time, computing when a subsequent scan window will begin.

9. The method of claim 8 further comprising avoiding transmitting advertising packets until the subsequent scan window begins.

10. The method of claim 8 wherein computing when the subsequent scan window will begin comprises:
dividing a result of the current time minus the start time by the scan interval to compute an elapsed time interval; and
computing REM=current time−(start time+elapsed time interval).

11. The method of claim 10 further comprising, based on REM being greater than the scan window, waiting a period of time equal to the current time plus the scan interval less REM before wirelessly transmitting advertising packets.

12. The method of claim 10 further comprising, based on REM being less than the scan window, wirelessly transmitting advertising packets.

13. An apparatus, comprising:
a controller configured to cause a wireless transceiver to send and receive packets;
wherein the controller is configured to generate a scan update packet that specifies a scan window length, a scan interval, a start time and an end time, wherein the scan window length and scan interval are valid between the start time and the end time.

14. The apparatus of claim 13 wherein the controller causes the wireless transceiver to wirelessly transmit the scan update packet.
